(19) United States
(12) Patent Application Publication
(10) Pub. No.: US 2013/0305495 A1
(43) Pub. Date: Nov. 21, 2013

(54) CORD MANAGEMENT DEVICE AND METHOD

(71) Applicant: Bruce Sho Umemoto, Gardena, CA (US)

(72) Inventor: Bruce Sho Umemoto, Gardena, CA (US)

(21) Appl. No.: 13/474,731

(22) Filed: May 18, 2012

(51) Int. Cl. H02G 15/00; H01F 7/02; B23P 11/00; F16G 11/00

(52) U.S. Cl. 24/303; 24/115 R; 29/428

(57) ABSTRACT

There is disclosed a collapsible cord management device (1) and method, said device (1) comprising a plurality of hollow elongated members; (10) each of said elongated members (10) having an opening extending along its length sufficiently sized to insert the cord (2) into the elongated member (10) and retained therein; wherein the plurality of hollow elongated members (10) are positioned in a manner such that there is a gap in between them (10) for providing flexibility so as to be collapsible for storage of the cord (2). Each of the elongated members may include magnetic materials or formed from ferromagnetic compound or compositions.

### FIELD OF INVENTION

Embodiments of the claimed invention relate to portable electronic devices in general, and more particularly to a cord management device intended to be used for portable electronic devices and method thereof.

### BACKGROUND

With the rapid growth of personal entertainment and communications technology, portable electronic devices have become indispensable in our daily lives, owing to its mobility and interpersonal convenience.

Common examples of portable electronic devices include audio players, communication devices and mobile computing devices. Users carry such devices in their bags, pockets or other suitable carrying or portable storing means. Usually these devices encompass a corresponding earphones or a cord attached to a hearing or audio element and to provide connection between the primary components to another electronic piece such as a hearing piece. It is often the case that without a proper storage system or apparatus the lengthy cord can become tangled or knotted and untangling can be another encumbrance to users.

Currently there are various means and methods available in the market used to prevent cords or cables tangling such as spools to which the cord is wound for holding it together when not in use, and another widely used technique, is by way wrapping said cord to an object. Nevertheless, a great majority of these means suffers from one or more flaws such as prone to unwinding if not stored or wound correctly thus the issue of tangling is not effectively addressed. In other instances, the winding to a spool or object of the likes can be time consuming.

One of the helpful attempts to resolve issues linked to cord tangling is as disclosed in United States Patent Application No 2011290532 (A. Cano, Miguel). This document teaches a headphone cord comprising a tubular sleeve having an opening on each end, a reinforcing section and a loop extending section. It is learned that from the disclosed information that the cord of an electronic device is extended through said tubular sleeve so as to create a form of resilience to tangling. In this assembly, although it may be effective to constrain the enclosed section of the cord, only one tube is provided at a predetermined length along the cord and thus the issue of tangling is still not thoroughly or efficiently addressed. In addition, storing in a small space may not be as convenient considering the length of the tube.

Accordingly, there remains a considerable need for a device and method for cord management that is minimally bulky and effectively prevents tangling during use or storage.

These and further objects and advantages will be apparent to those skilled in the art in connection with the drawings and then detailed description of the embodiments set forth below.

### SUMMARY OF INVENTION

In one aspect of the claimed invention there is provided a foldable cord (2) management device comprising: a plurality of hollow elongated members; (10) each of said elongated members (10) having a lateral opening extending along its length sufficiently sized to insert the cord (2) into the elongated member (10) and retained or clasped therein.

In another aspect of the claimed invention, the plurality of hollow elongated members (10) are positioned in a manner such that there is a gap in between them (10) for providing flexibility so as to be collapsible or foldable for storage of the cord (2).

In yet another aspect of the claimed invention, when the device is in storage position the plurality of hollow elongated members (10) aids to fold said cord (2) into multiple segments in an organized manner.

In another aspect of the claimed invention, in attaching the device to the cord (2) the cord (2) is inserted or pushed through the inlet (11).

In yet another aspect of the claimed invention, ridges are formed on an internal surface of the hollow elongated member (10) for providing gripping effect to the cord (2).

In a further aspect of the claimed invention, each of the hollow elongated members (10) is provided with a magnetic material or element; wherein there can be least one magnetically attracting section and at least one magnetically attractable section.

In another aspect of the claimed invention, each of the hollow elongated members (10) is formed from ferromagnetic compound or composition.

In yet another aspect of the claimed invention there is provided a cord management method comprising the steps of: providing a plurality of elongated members (10) having a lateral opening along its length; inserting the cord (2) into said opening to attach said members to the cord (2); attaching said plurality of elongated members (10) along the length of the cord (2); providing a gap in between each elongated member attached to the cord; folding said cord (2) into multiple segments corresponding to the length of the elongated members (10).

Various objects, features, aspects, and advantages of the present invention will become more apparent from the following detailed description of preferred embodiments of the invention, along with the accompanying drawings in which like numerals represent like components or members.

### BRIEF DESCRIPTION OF THE DRAWINGS

Features of the claimed invention will be apparent from the following description when read with reference to the accompanying drawings:

FIG. 1 (a) illustrates an overall view of the device in accordance with the preferred embodiments of the claimed invention; attached to a generic earphone cord;

FIG. 1 (b) shows an enlarged view of the device being attached to a section of the cord in accordance with another preferred embodiment of the claimed invention; and

FIG. 2 illustrates the device in a folded position ready for storage in accordance with the preferred embodiments of the claimed invention.

### DETAILED DESCRIPTION

In the following description, reference is made to the accompanying drawings where, by way of illustration, specific embodiments of the claimed invention are shown. It is to be understood that other embodiments may be used as structural and other changes may be made without departing from the scope of the claimed invention. Also, the various embodiments and aspects may be used in any suitable combinations. The drawings and detailed description are to be regarded as illustrative in nature and not as restrictive.

Embodiments of the claimed invention are directed to a cord management device and method thereof having the object of solving the previously discussed drawbacks in an improved and effective manner.

As used herein the term “cord” is intended to include wires, cables or means of the likes for providing electrical connection between electronic devices, members or apparatus.

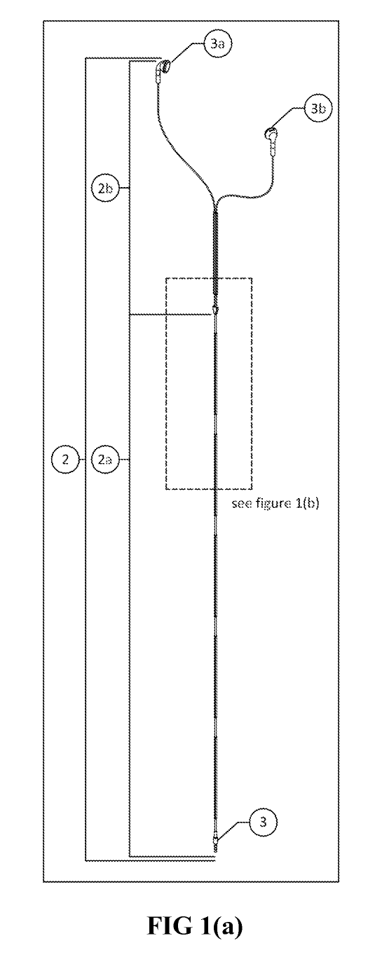

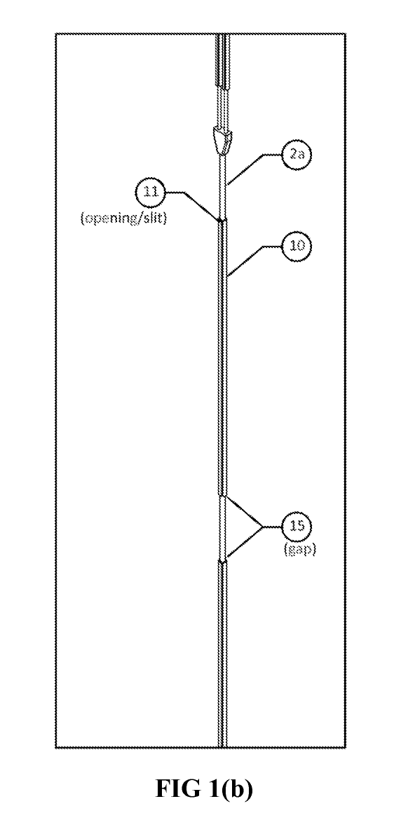

FIG. 1 (a) and FIG. 1(b) generally illustrate the cord managing device attached to a generic earphone cord (2) or cable in accordance to a preferred embodiment of the claimed invention. As shown in FIG. 1(a), said cord (2) may comprise of a main cord (2a) or lower cord section having a connecting piece (3) at one end for connection to the electrical device, and an upper cord section (2b) which is connected to a pair of earpieces (3a, 3b) from the main cord (2a). The device comprises a plurality of elongated hollow members (10); to be attached along the length of the earphone cord (2), said attachment method or technique will be further elucidated herein below. FIG. 1(b) specifically shows an enlarged view of one section of the cord (2a) attached with the cord-managing device.

In the illustrative embodiment, each elongated hollow member (10) can be formed from polymer-based materials, fiber-based or other suitable non-ferrous materials known in the art, provided each member is formed to be resilient, with sufficient stiffness or in a way able to spring back to its original shape if bent. In one embodiment, the elongated members are formed with equal length for ease of storage, the mechanism to be elucidated further below. The length of the elongated member (10) may range from 10 to 13 cm; or a suitable length, preferably a length that does not result to extreme bulkiness and weight increment when folded.

Each of the elongated members (10) is adapted in a manner such that it can hold or clasp the cord (2) and thus partially enclosing the cord (2) when attached. In addition, it prevents from tangling when in storage position. Each elongated member (10) is formed with a predetermined length, whereby accumulatively these members (10) can at least partially enclose the total length of the cord (2). Along the middle length of each elongated member (10) there is defined an opening or slit (11) defined in a manner such that it extends from the one end to the other; sufficiently sized for insertion of the length of the cord (2). The thickness of the slit or opening may be a quarter (¼) of the cord's thickness. Accordingly, the width of the slit (11) is preferably smaller than that of the cord (2) such that the cord (2) can be fitted into the member (10) but at the same time the cord (2) is prevented from falling out freely through said slit (11). Providing such opening enables the members (10) to be detachable and thus can be detached from the cord (2) whenever required by the user.

In one embodiment, the elongated hollow member (10) may be flattened so it may clamp the cord (2) and to some extent constrains the movement of cord (2). In another alternative embodiment, on one internal surface of the elongated member (10) there can be formed ridges or corrugations so as to provide sufficient gripping of the cord (2).

In accordance with the preferred embodiments of the claimed invention, the elongated members (10) may be of various cross sections such as, but not limiting to, circular, rectangular or whichever suitable to achieve the desired effects of the claimed invention.

In attaching the device to the cord (2) for use, at least a portion of cord (2) is inserted or pushed into each elongated member (10) through the slit (11) so as to partially enclose the respective portion of the cord (2) accordingly. The cord (2) therefore fits snugly and is clasped within the elongated members (10). As there is a plurality of elongated members (10), the members are therefore disposed in series corresponding to the length of the cord (2), however leaving a minor gap (15) or an uncovered segment thus exposing the corresponding cord (2) segment in between each elongated member (10), the distance sufficient to provide flexibility for the device to be collapsible or foldable for storage. The gap (15) distance may range within 1.0 mm to 1.5 mm. According to the preferred embodiments of the claimed invention, there can be provided eight elongated members (10) for an overall length of a typical earphone cord; whereby six elongated members (10) detachably attached to the main cord (2a) and at least one covers each branched out cord (2b) which connects the earpiece to the main cord (2a). It is understood that the number of elongated members (10) may vary based on the length of the cord (2).

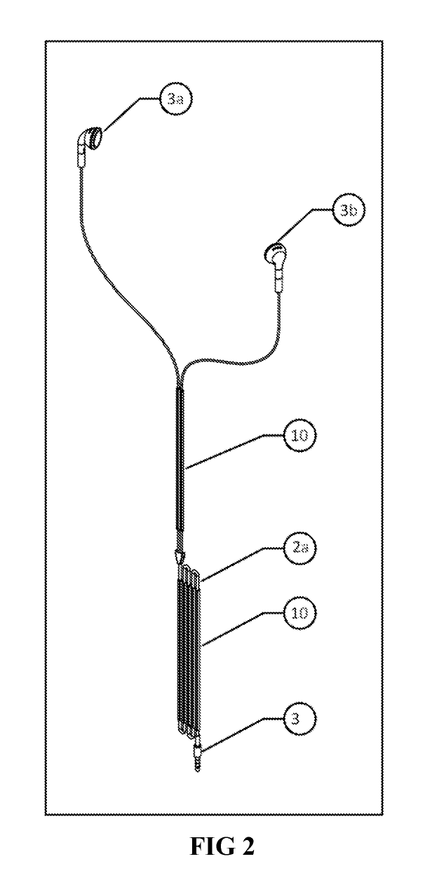

FIG. 2 shows the cord (2) together with the device in folded position. In this position, at least one surface of each member is in contact with the other as seen in FIG. 2. The cord (2), being clasped within the elongated members (10) is folded into multiple and smaller segments. Accordingly, the possibility of tangling is substantially reduced if not eliminated entirely and as the cord (2) is folded with the members (10) into multiple segments as shown in FIG. 2, making it space-efficient.

### Second Embodiment

In a second embodiment of the claimed invention the elongated members (10) are formed with or removably attached with a magnetic material or element and also having at least one slit (11) for insertion of cord (2). The magnetic material may be formed integrally or secured thereto by way of suitable fastening means.

Understandably, there can be various ways of providing the magnetic element on each elongated member (10). The magnetic material (not shown) may be provided in the form of a magnetic strip or any suitable dimension, sufficient to provide a force to attract ferrous materials towards it. The magnetic material may be formed by various known in the art processes or methods, such as, extrusion, mold injection or the likes. In another preferred embodiment, the elongated members (10) are formed from a ferromagnetic compound or composition thus allowing these members to be ferromagnetic. In a preferred alternative, each elongated member (10) can be coated with a ferromagnetic compound or composition so as to achieve a magnetically adhesive effect or magnetic attraction when folded for storage. Such coating can be provided by way of conventional techniques including spraying, printing, dipping or brushing.

The said slit (11) can be in the form of a predetermined sized slit similar to that of the first embodiment discussed earlier in which the cord (2) can be easily inserted or rather pushed through said slit (11) and thus enclosed by said magnetic member (10). Preferably, there is a plurality of magnetic elongated members (10) to enclose the cord.

For this embodiment, in attaching the device to the cord (2) for use, the cord (2) is accordingly fitted within each of the hollow elongated magnetic members (10) by inserting or pushing said cord (2) through the slit (11) on each member (10). Similar to that of the embodiment as described in the preceding paragraphs, the elongated magnetic members (10) are arranged in series having a minor gap or a free segment in between them so as to provide flexibility thus to be collapsible for storage. With magnetic adhesion between the elongated members (10), the possibility of cord (2) tangling can be substantially reduced, thus folding the cord (2) into segments is easier and more convenient in terms of storage in pockets or bags.

From the above disclosure it is seen that the foldable device and method of the claimed invention is of simple construction however providing effective solution in preventing tangling of the cord or wire of an electronic device. Accordingly, users can conveniently place the folded cord into various forms of storage means thus preventing said cord from tangling when placed in such storage means such as bags, pockets, and the likes.

Thus, specific arrangements and combinations of a cord management device and method have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A cord (2) management device comprising: a plurality of hollow elongated members; (10) each of said elongated members (10) having an opening extending along its length sufficiently sized to insert the cord (2) into the elongated member (10) and clasps the cord (2) therein;
wherein the plurality of hollow elongated members (10) are positioned in a manner such that there is a gap in between them (10) for providing flexibility so as to allow the cord (2) to be foldable for storage of the cord (2).

2. The cord management device (1) according to claim 1 wherein the device partially encloses the cord (2).

3. The cord management device according to claim 1 wherein the opening is in the form of a slit (11).

4. The cord management device according to claim 1 wherein each of the hollow elongated members (10) is formed from a resilient or non-ferrous material.

5. The cord management device according to claim 1 wherein in attaching the device to the cord (2) the cord (2) is inserted or pushed through the slit (11).

6. The cord management device according to claim 1 wherein ridges may be formed on an internal surface of the hollow elongated member (10) for providing gripping effect to the cord (2).

7. The cord management device according to claim 1 wherein the hollow elongated member (10) is provided with a magnetic material or element.

8. The cord management device according to claim 1 wherein the hollow elongated member (10) is formed from ferromagnetic compound or compositions.

9. The cord management device according to claim 7 wherein the hollow elongated member (10) is provided with at least one magnetically attracting section and at least one magnetically attractable section.

10. The cord management device according to claim 7 wherein the elongated members (10) effectively attract each other when folded for storage.

11. The cord management device according to claim 7 wherein the elongated members are formed with equal length.

12. The cord management device according to claim 1, wherein the length of each elongated member (10) is approximately within the range of 10 to 13 cm.

13. The cord management device according to claim 1, wherein there are eight elongated members (10) attached to the cord.

14. The cord management device according to claim 1, for use with an earphone cord.

15. A cord management method comprising the steps of: providing a plurality of elongated members (10) having a lateral opening along its length; inserting the cord (2) through said opening to attach said members to the cord (2); attaching said plurality of elongated members (10) along the length of the cord (2); providing a gap in between each elongated member attached to the cord (2); folding said cord (2) into multiple segments corresponding to the length of the elongated members (10).

16. The cord management method as claimed in claim 15 wherein the method further comprises the step of providing a magnetic material on each elongated member.

17. The cord management method as claimed in claim 15, wherein the step of providing a magnetic material on each elongated member (10) further comprises the step of providing at least one magnetically attracting section.

18. The cord management method as claimed in claim 15, wherein the step of providing a magnetic material on each elongated member (10) further comprises the step of providing at least one magnetically attractable section.
